(19) United States
(12) Patent Application Publication
(10) Pub. No.: US 2007/0214651 A1
(43) Pub. Date: Sep. 20, 2007

(54) Cutting tool

(76) Inventor: Matteo Thun, Mailand (IT)

Correspondence Address: HARNESS, DICKEY & PIERCE, P.L.C., P.O. BOX 828, BLOOMFIELD HILLS, MI, 48303, US

(21) Appl. No.: 11/724,685

(22) Filed: Mar. 15, 2007

(30) Foreign Application Priority Data
Mar. 16, 2006 (DE) 20 2006 004 157.5

(51) Int. Cl. B26B 3/00; B26B 11/00

(52) U.S. Cl. 30/142; 30/161

(57) ABSTRACT

The bolster of a knife is engraved with information about the knife and also provides slip-resistant texture for the user's thumb.

### BACKGROUND OF THE INVENTION

1. Field of the Invention

The invention relates to a cutting tool, in particular knives, with a blade body and a handle piece arranged thereon, whereby blade body has an information sign in the form of an engraving.

2. Discussion

Cutting tools of the aforementioned kind have been known per se from the prior art. Usually, cutting tools have an information sign on them which is made by the manufacturer and attached to the cutting tool. It is supposed to give the future user information for instance about who is the manufacturer of the cutting tool, the exact designation of the cutting tool, the material the blade body and/or the handle piece are made of, whether the cutting tool is dishwasher-safe, and the like.

The information signs known from the prior art are applied in the form of an etching to one or both sides of the blade body of the cutting tool. Due to abrasion wear in the course of cleaning cycles of a cutting tool, the etching, however, becomes adversely illegible or disappears completely. An identification of the cutting tool type, cutting tool manufacturer, or the like is then not possible any more. An information sign may also be an adhesive label with usually a self-adhesive back which is attached to the blade body by the manufacturer. This also results in a series of disadvantages. On the one hand, the information sign designed as an adhesive label is not permanently connected with the blade body of the cutting tool. It can come off the blade body even if the cutting tool is used as intended. The information to be conveyed by means of the information sign is then lost to the disadvantage of the user. An additional advantage is that the adhesive used for arranging the information sign on the blade body may corrode the material of the blade body, which can lead to undesirable, since unsightly discolorations of the blade body material.

### SUMMARY OF THE INVENTION

For the solution of these problems, it is proposed that the bolster of blade body has the information sign on its upper side, whereby the information sign designed as an engraving has an engraving profile (engraving layout) such that it serves as a non-slip device.

Unlike a conventional information sign designed as an adhesive label or an etching, the information sign according to the invention in the form of an engraving is inextinguishably arranged on the blade body of the cutting tool when used as intended. An unintentional separation of the information sign is therefore safely prevented. Even after years of use of the cutting tool according to the intended purpose, the information conveyed by the information sign is recognizable to the user.

The information sign contains at least information about who is the manufacturer of the cutting tool. This makes it possible for the user of the cutting tool to be able to clearly identify the manufacturer of the same at any time, which is advantageous in so far as the user can turn directly to the manufacturer, should any questions arise with regard to the product.

Moreover, the information sign can of course also provide further information for the user, as for instance recommendations for use, directions for use, or the like. Material specifications, more detailed designations or the like may also be included in the information sign. To this extent, there are no limits to the range of application.

In a preferred embodiment of the invention, the bolster of the blade body carries the information sign. The functional use of the cutting tool is not impaired by the arrangement of the information sign on the bolster of the blade body.

Particularly preferred is an embodiment where the bolster of the blade body has the information sign on its upper side. In this case, the information sign designed as an engraving serves additionally as a non-slip thumb rest, i.e. it provides skid resistance. For this purpose, the profile of the engraving of the information sign, i.e. the layout of the engraving, must be designed accordingly.

The information sign is preferably produced by means of laser engraving. This is particularly suitable if the blade of the cutting tool is laser-finished. What is decisive is that the information sign is not—as has previously been known from the prior art—designed as an adhesive label or an etching, but as an information sign which is inextinguishable when the cutting tool is used as intended.

### BRIEF DESCRIPTION OF THE DRAWINGS

Other features and advantages of the invention result from the following description on the basis of the figures. In these figures:

FIG. 1 is a cutting tool according to the invention in a side view, and

FIG. 2 is the cutting tool according to the invention pursuant to FIG. 1 in a plan from above according to line of sight II-II pursuant to FIG. 1.

### DESCRIPTION OF THE PREFERRED EMBODIMENTS

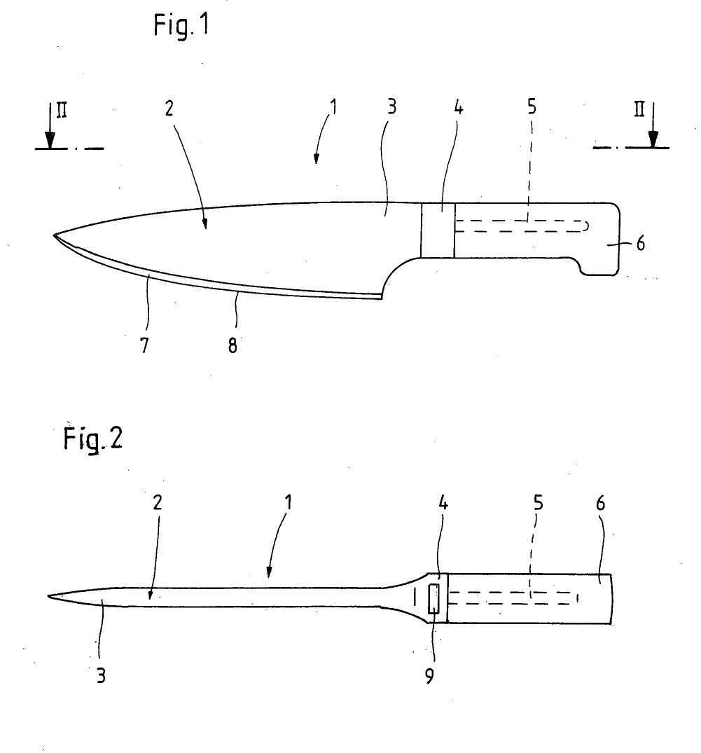

FIG. 1 shows the cutting tool 1 according to the invention in a side view. The cutting tool has a blade body 2 and a handle piece 6 arranged thereon. In the embodiment shown here, the blade body 2 consists of a non-corroding material, as for instance stainless steel, while the handle piece 6 is made of plastic. The handle piece 6 is supported by a tang 5 which, together with bolster 4 and blade 3, forms the blade body 2. However, the invention is not restricted to such a design. The invention rather also includes cutting tools in which the blade bodies 2 and handle pieces 6 are designed integrally.

In the embodiment according to FIGS. 1 and 2, the blade body 2 consists of a blade 3, a bolster 4, and a tang 5, whereby the bolster 4 represents the transition area between blade 3 and handle piece 6, as can be seen in particular from FIG. 2.

In a manner known per se, blade 3 comprises an edge area 7, one end of which merges into a cutting edge, the so-called facet 8 of the blade 3.

According to the invention, the cutting tool shown in FIGS. 1 and 2 has an information sign 9 in the form of an engraving. The latter, as can be seen in particular from FIG. 2, is formed on the upper side of bolster 4. The advantage of this embodiment is that the engraving serving as information sign 9 serves as a non-slip thumb rest at the same time and, in contrast to a labelling on one or the other side of the blade body 2, can be recognized conveniently and easily from above when used as intended.

The information sign 9 is preferably made by means of laser engraving. Other embodiments, however, are also imaginable, and included in the scope of the invention.

What is claimed is:

1. Cutting tool, in particular knives, with a blade body (2) and a handle piece (6) arranged thereon, whereby blade body (2) has an information sign (9) in the form of an engraving,
characterized in that
the bolster (4) of blade body (2) has the information sign on its upper side, whereby the information sign (9) designed as an engraving has an engraving profile (engraving layout) such that it serves as a non-slip device.

2. Cutting tool according to claim 1, characterized in that the information sign (9) is made by means of laser engraving.

3. A knife comprising:
a blade having a cutting edge;
a handle for gripping the knife;
a bolster between the blade and the handle, the bolster having a top portion that extends perpendicular to the blade; and
indica formed in the top portion of the bolster about the knife.

4. The knife of claim 3 wherein the indica runs perpendicular to the blade and forms a roughness in the bolster to act as a slip-resistant area for the thumb of the user.

5. The knife of claim 4 wherein the indica is engraved into the top portion of the bolster.
